(19) United States
(12) Patent Application Publication
(10) Pub. No.: US 2016/0042381 A1
(43) Pub. Date: Feb. 11, 2016

(54) METHODS, SYSTEMS AND COMPUTER READABLE MEDIA FOR PROVIDING BENEFITS TO LOCAL COMMUNITY ENTITIES VIA PURCHASE CARD TRANSACTIONS

(71) Applicant: MasterCard International Incorporated, Purchase, NY (US)

(72) Inventors: William B. Braine, Cornwall-on-Hudson, NY (US); Ellen C. Heitman, St. Louis, MO (US); Michael W. Smith, Ridgefield, CT (US); Nicole V. Ward, Stamford, CT (US); Veronica L. Kent, Wildwood, MO (US)

(21) Appl. No.: 14/455,453

(22) Filed: Aug. 8, 2014

(51) Int. Cl. G06Q 30/02

(52) U.S. Cl. CPC G06Q 30/0215; G06Q 30/0226; G06Q 30/0279

(57) ABSTRACT

Methods, systems, and computer readable media for providing benefits to local community entities via purchase card transactions are disclosed. In one example, the method includes receiving a message indicating that a purchase transaction has been initiated with a purchase transaction card associated with a community-based payment card reward program managed via the website management platform, using purchase transaction information contained in the message to determine if the purchase transaction was conducted in a local area specified by the community-based payment card reward program, applying a credit to a cardholder account associated with the purchase transaction card in the event the purchase transaction is initiated at a merchant site located within the local area and determining a donation amount to be provided to at least one charitable entity located within the local area in the event the purchase transaction is initiated at a merchant site located outside of the local area.

### TECHNICAL FIELD

The subject matter described herein relates to payment card transactions and associated reward programs. More particularly, the subject matter described herein relates to systems, methods, and computer readable media for providing benefits to local community entities via payment card transactions.

### BACKGROUND

Although numerous co-branded payment cards and purchase-dependent loyalty card programs currently exist, these card products are typically characterized has having onerous and/or exclusionary purchasing requirements. Moreover, the operation and reward disbursement of such payment card programs are typically merchant-funded. Thus, such payment card programs are restrictive and provide limited value to most independent merchants. Notably, these independent merchants are typically compelled to operate within the constraints of narrow profit margins which make it difficult for the merchant entities to remain competitive with large chain merchants and e-commerce entities. More importantly, such operating conditions offer little to no incentive, monetary or otherwise, for consumers to provide their patronage to these local merchants and stores.

Accordingly, there exists a need for improved systems, methods, and computer readable media for providing benefits to local community entities via payment card transactions.

### SUMMARY

According to one aspect, the subject matter described herein relates to, methods, systems, and computer readable media for providing benefits to local community entities via payment card transactions. In one embodiment, the method includes receiving, by a website management platform, a message indicating that a purchase transaction has been initiated with a purchase transaction card associated with a community-based payment card reward program managed via the website management platform and using purchase transaction information contained in the message to determine if the purchase transaction was conducted in a local area specified by the community-based payment card reward program. The method further includes applying a credit to a cardholder account associated with the purchase transaction card based on a monetary amount of the purchase transaction in the event the purchase transaction is initiated at a merchant site located within the local area and determining, based on the monetary amount associated with the purchase transaction, a donation amount to be provided to at least one charitable entity located within the local area in the event the purchase transaction is initiated at a merchant site located outside of the local area.

The subject matter described herein may be implemented in hardware, software, firmware, or any combination thereof. As such, the terms “function”, “node”, or “module” as used herein refer to hardware, which may also include software and/or firmware components, for implementing the feature being described. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a block diagram illustrating an exemplary system for providing benefits to local community entities via purchase card transactions according to an embodiment of the subject matter described herein;

FIG. 2 is an exemplary screen display of a web portal that may be utilized by an issuer entity to register for the community-based payment card reward program according to an embodiment of the subject matter described herein;

FIG. 3 is an exemplary screen display of a web portal that may be utilized by a cardholder user to enroll in the community-based payment card reward program according to an embodiment of the subject matter described herein;

FIG. 4 is an exemplary screen display of a web portal that may be utilized by a cardholder user to monitor and manage the community-based payment card reward program according to an embodiment of the subject matter described herein; and

FIG. 5 is a flow chart illustrating an exemplary process for providing benefits to local community entities via purchase card transactions according to an embodiment of the subject matter described herein.

### DETAILED DESCRIPTION

In accordance with the subject matter disclosed herein, methods, systems, and computer readable media for providing benefits to local community entities via payment card transactions are disclosed. In some embodiments, the disclosed subject matter is implemented as a website management platform that is aimed toward proving a community-based payment card reward program that benefits the independent banks and credit unions (IBCU) segment. Notably, the website management platform may be embodied as a “buy-local engine” that is directed to a large and growing “localist” movement that dedicates efforts for supporting small merchant entities operating in the local area or community. As used herein, a “local area” comprises any geographic area defined (e.g., via one or more 5-digit zip codes, 9-digit zip codes, a telephone phone area code, etc.) as a local community. The website management platform may be leveraged in order to enable participating cardholder users to manage and monitor the amount of spend and associated rewards afforded to the cardholder user and local community charities alike.

The community-based payment card reward program further enables local independent banks (i.e., local issuer entities) to compete with larger regional and national banking entities by catering to the prevailing desire of customers to retain money in their local communities. Notably, the present subject matter effectively directs customer traffic to local businesses at little to no cost to such local businesses. Local merchants are also incentivized, by the potential for increased revenue, to cross-promote the associated payment card product via partnership with local independent banks, which are often providing commercial banking services to those local merchants. Charitable entities in the community are also benefited as out-of-area spending may generate donations to local nonprofit organizations.

In some embodiments, the disclosed subject matter includes a program management server that can be configured to host and support a plurality of community-based payment card reward programs associated with a plurality of local issuer entities, such as local community banks or credit unions. Specifically, a single community-based payment card reward program may be managed and funded by a local independent issuer entity. For each community-based payment card reward program, a local issuer entity may issue a locally-branded payment card (e.g., a plastic magnetic stripe credit card and/or an electronic based virtual softcard, each of which may display the local issuer logo and/or card image on the front face) to enrolled cardholders in addition to funding a two-prong reward program that is directed to generally benefit the local community in some manner regardless of where purchase transactions are actually conducted. For example, in the event an issued community-based payment card is used by a cardholder to conduct a purchase transaction at merchant store within the local community area, the issuer entity may be directed to fund the cardholder's account with a statement-credit (e.g., a credit refund or reward) amounting to a predefined percentage (e.g., 1%) of the local purchase transaction. Conversely, in the event the issued payment card is used by a cardholder to conduct a purchase transaction at a merchant store located outside of the local community area, the issuer entity may be directed to earmark and/or forward donation funds amounting to a predefined percentage (e.g., 1%) of the non-local purchase transaction to a designated charitable organization located in the community. Although the present disclosure herein describes the conducting of a purchase transaction at a “merchant store,” the aforementioned transaction may be performed at a location associated with any type of provider of goods, products, and/or services (e.g., a hardware store, a law firm, a dentist office, a movie cinema, a medical supply wholesaler, etc.) that is located in the community without departing from the scope of the disclosed subject matter.

Notably, the program management server and its components and functionality described herein constitute a special purpose device that improves the technological field of payment card reward programs by providing i) a community-based payment card reward program that is funded by the issuer entity, ii) a website management platform that enables both the issuer entity and cardholders alike to customize the community-based payment card reward program, and iii) a monetary benefit for one or more of a plurality of local community entities (e.g., incentivized purchases at local merchant entities and donation awards for charitable entities) regardless of where the community-based payment card is used.

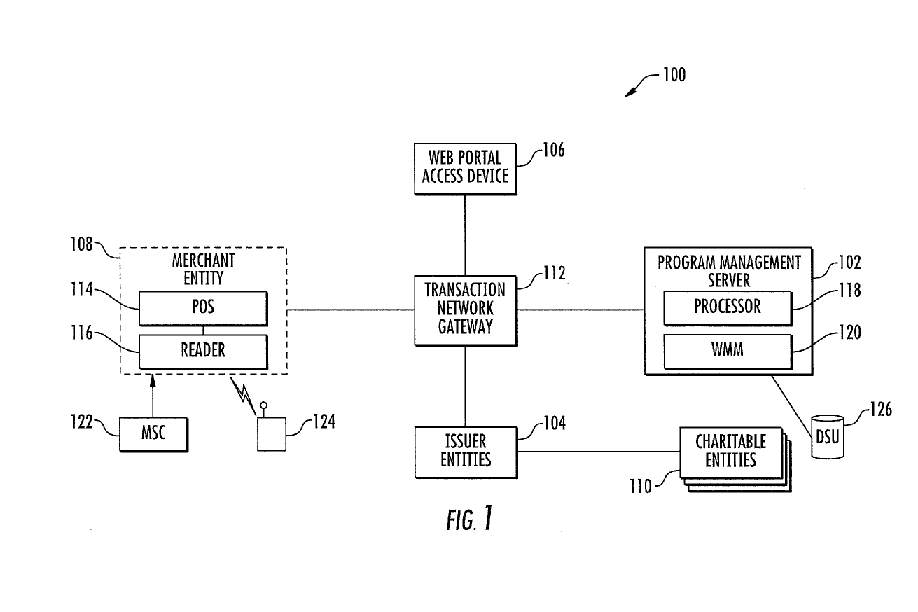

Although the following description discloses the use of a MasterCard payment network, other third party networks or entities may utilize the methods and systems disclosed herein without departing from the scope of the present subject matter. FIG. 1 depicts an exemplary purchase transaction system 100 that includes a program management server 102, an issuer entity 104, a web portal access device 106, at least one merchant entity 108, a plurality of charitable entities 110, and a transaction network gateway 112. FIG. 1 further depicts merchant entity 108 comprising a, point of sale (POS) device 114 and a reader device 116. Reader device 116 may include a magnetic stripe card reader that may read data from a magnetic stripe card 122 that is swiped at reader device 116 and/or a wireless device reader that is configured to wirelessly read data from smart cards and/or an NFC-enabled mobile device 124 brought in proximity to reader device 116. As shown in FIG. 1, each of components 102-110 may be embodied as a computer server and/or computer network node capable of electronic communications (e.g., via the Internet) with the other remaining components.

In some embodiments, program management server 102 may include any server, node, computer, or unit that is configured to both i) process registrations made by issuer entities and cardholder users, ii) implement management and monitoring tasks using the methods described herein, and iii) utilize received purchase transaction data to execute the community-based payment card reward program. One non-limiting example of a program management server 102 may include a processing hub or network element associated with MasterCard Main Street, a community reward service from MasterCard International Incorporated of Purchase, N.Y., USA, which facilitates the implementation of a website management platform that may be used by both issuer entities and cardholder users to manage and monitor aspects of a community-based payment card reward program. Although FIG. 1 depicts program management server 102 as a single network element, program management server 102 may include a plurality of network elements, a plurality of network components, and/or a network itself (e.g., a MasterCard Network) without departing from the scope of the present subject matter. In some embodiments, program management server 102 may further include a payment card reward system.

In some embodiments, program management server 102 may include at least one processor 118 and a website management module (WMM) 120, which may be configured to support the registration of an issuing entity as well as the enrollment of a cardholder user. In some embodiments, processor 118 may include a microprocessor, central processing unit (CPU), or any other like hardware-based processor unit that is configured to execute and/or utilize website management module 120 (e.g., a software based algorithm) to communicate with a data storage unit 126, which may be configured to store a plurality of different community-based payment card reward programs (i.e., reward program parameters, qualifications, etc.). In some embodiments, website management module 120 may be stored in memory (not shown), such as random access memory (RAM), read only memory (ROM), optical read/write memory, cache memory, magnetic read/write memory, flash memory, or any other non-transitory storage media. In one embodiment, processor 118 and the aforementioned memory may be used to execute and manage the operation of website management module 120. In some embodiments, data storage unit 126 may include any storage medium that is configured to store subscriber profile data and community-based payment card reward program data associated with one or more registered cardholder users. Exemplary data storage units may include one or more external database servers accessible by program management server 102. Alternatively, data storage unit 126 may include a local database hosted by program management server 102. In some embodiments, data storage unit 126 may be provisioned with a plurality of profiles that include the specific parameters corresponding to the community-based payment card reward programs operated by program management server 102.

In some embodiments, a representative (e.g., an issuer bank administrator) associated with issuer entity 104 may access a website management platform supported by website management module 120 to register issuer entity 104 as a participant in a community-based payment card reward program hosted by program management server 102. As used herein, an “issuer entity” may include an independent bank or credit union that is licensed and authorized program management server 102 (e.g., MasterCard International) to issue payment cards (e.g., credit cards, prepaid cards, etc.) to enrolling consumers. Examples of issuer entities include local independent bank entities, local credit union entities, and the like.

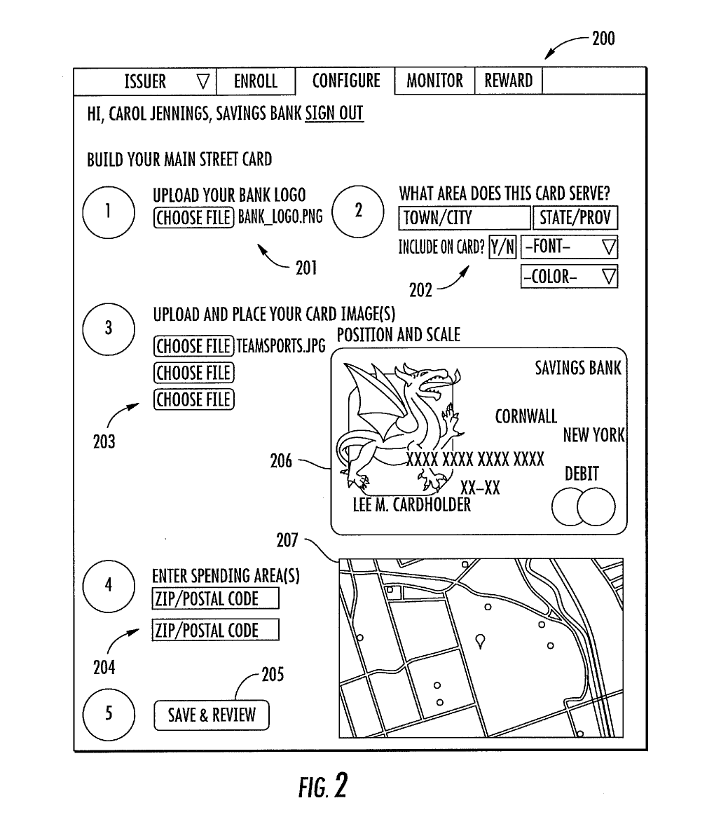

Likewise, website management module 120 may support a website management platform that includes a configuration webpage associated with a community-based payment card reward program. For example, FIG. 2 illustrates an exemplary screen display of a configuration webpage 200 that may be utilized by an issuer entity to configure and customize the issuing entity's community-based payment card reward program. Specifically, configuration webpage 200 includes a plurality of different user interface (UI) elements that enable a user, such as an issuer entity administrator, to configure the specific parameters and characteristics of the community-based payment card reward program. For example, configuration webpage 200 includes a first UI element 201 that is configured to enable the user to upload an independent bank or credit union logo image, locality artwork image, or the like. By utilizing UI element 201, a user may select an image file (e.g., a .jpg file, a .png file, etc.) that displays the logo of the issuing entity (e.g., independent bank or credit union) on the front face of an enrolled cardholder's payment card (e.g., either a physical plastic magnetic stripe card or a softcard image displayed on the screen of a mobile device). Webpage 200 further includes a second UI element 202 that may enable a user to input the area of service (e.g., town, city, county, state, province, and/or country) associated with the enrolling issuer entity. In some embodiments, second UI element 202 may also provide the user the choice to customize (e.g., font, point size, print color etc.) this information on the front face of a payment card issued to a registered cardholder.

Similarly, webpage 200 includes a third UI element 203 that permits a user to upload one or more card images to application server 102. By utilizing UI element 203, a user may select one or more image files (e.g., a .jpg file, a .png file, etc.) that are subsequently presented to an enrolling cardholder as options for a front face image that is to be ultimately displayed on the cardholder's payment card (e.g., either a physical plastic magnetic stripe card or a softcard image displayed on the screen of a mobile device). Webpage 200 may further include UI element 206 that enables a user to modify (e.g., resize, crop, scale, reposition, etc.) the main card image by clicking and dragging. In addition, the uploaded and modified images saved via webpage 200 may be displayed to enrolling cardholder as options for their payment card design (as discussed below). Notably, webpage 200 provides a plurality of UI elements that enables a user to select and modify the front-facing image(s) on a community-based payment card regardless of form (e.g., physical magnetic stripe card or electronic softcard).

In some embodiments, webpage 200 further includes a fourth UI element 204 that allows a user to designate one or more spending areas that qualify as a “local area”. For example, UI element 204 may include fields and/or windows that are configured to receive the text input of postal zip codes that can be used to identify and establish the “local area” designation associated with the community-based payment card reward program. Webpage 200 may also include a UI element 207 that can display an embedded map corresponding to one or more of the designated zip codes. In some embodiments, webpage 200 also includes a fifth UI element 205 that allows a user to save and review the registration information to be submitted. Such an option may be used to save the user's selections, load a webpage displaying all of the payment card programs and designs, and preview an associated template consumer-facing webpage that enrolled cardholders may view. Upon acquiring the cardholder's enrollment information and input via webpage 200, program management server 102 may provide a relevant portion or all of the received cardholder's data to issuer entity 104, which subsequently generates and provisions an associated community-reward payment card including the cardholder's customized designs. Alternatively, in some embodiments, program management server 102 may be configured to handle the payment card generation and provisioning responsibilities.

Returning to FIG. 1, web portal access device 106 may be utilized by a user to enroll in and manage a community-based payment card reward program (e.g., a program established and/or configured above via webpage 200 in FIG. 2) hosted by program management server 102. In some embodiments, web portal access device 106 may also comprise any computing device (e.g., a personal computer, a mobile smartphone device, a tablet computer, etc.) that is provisioned with an application (e.g., a web browser application or mobile phone app) that may establish communication with and access a website management platform or website associated with the community-based payment card reward program supported by website management module 120. For example, web portal access device 106 may be utilized by a user to enroll in and manage a community-based payment card reward program hosted by program management server 102. As a user utilizes the website management platform to enroll/register with the community-based payment card reward program, the cardholder may also configure his/her cardholder profile to designate one or more of charitable entities 110 (and respective percentages if more than one charitable entity) as recipients of donations generated via non-local purchases.

As used herein, each of charitable entities 110 may include any type of charity organization that has been identified as qualified potential recipients of donation funds generated by a cardholder's use of a payment card associated with a community-based payment card reward program. In some embodiments, charitable entities 110 are geographically located within the designated local area established by the community-based payment card reward program managed by issuer entity 104. Exemplary charitable entities may include, but are not limited to, non-profit charity organizations, not-for-profit charity organizations, tax exempt charity organizations, taxable charity organizations, religious charity organizations, and the like. The manner in which an issuer entity determines whether a charitable entity is identified and qualifies for participation in the community-based payment card reward program is beyond the scope of the present subject matter. In some embodiments, charitable entities 110 may receive a donation award disbursement (e.g., a check) directly from issuer entity 104. Although FIG. 1 depicts charitable entities 110 as being communicatively connected with issuer entity 104, charitable entities 110 may in some embodiments represent the bank or credit union servers that serve the aforementioned charitable entities and are configured to directly receive electronic-based donation award deposits from issuer entity 104.

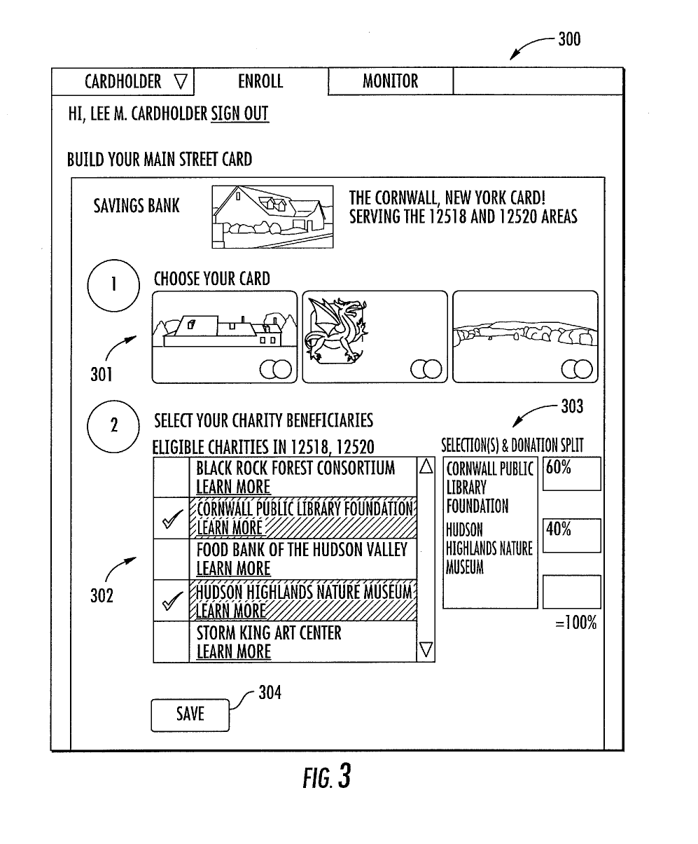

FIG. 3 illustrates an exemplary screen display of a web portal that may be utilized by a consumer user to enroll in a community-based payment card reward program. For example, webpage 300 in FIG. 3 includes a first UI element 301 that enables an enrolling cardholder user to select one of a plurality of payment card images to be used on the front face of a community reward payment card to be issued. Notably, the payment card images displayed via UI element 301 were originally uploaded by the issuer entity via UI element 203 (in FIG. 2). Using UI element 301, a cardholder user may select (e.g., hover and/or click) one of the displayed card images to designate a payment card image.

Webpage 300 further includes a second UI element 302 that lists a plurality of qualified charitable entities that may be selected by a cardholder user as recipients and/or beneficiaries of a donation amount. Specifically, the listed charitable entities may include non-profit charity organizations located within the zip code areas previously designated by the issuer entity (e.g., via UI element 204 in FIG. 2). In some embodiments, the listed charity organizations may be obtained from a third party database (e.g., purchased or government sourced database). Similarly, webpage 300 may include a third UI element 303 that enables a cardholder user to designate and/or apportion percentages of an overall accumulated donation reward to the charitable entities selected via UI element 302. Webpage 300 may also include a fourth UI element 304 (e.g., a “save” button) that allows the user to save the selections made via UI elements 301-303.

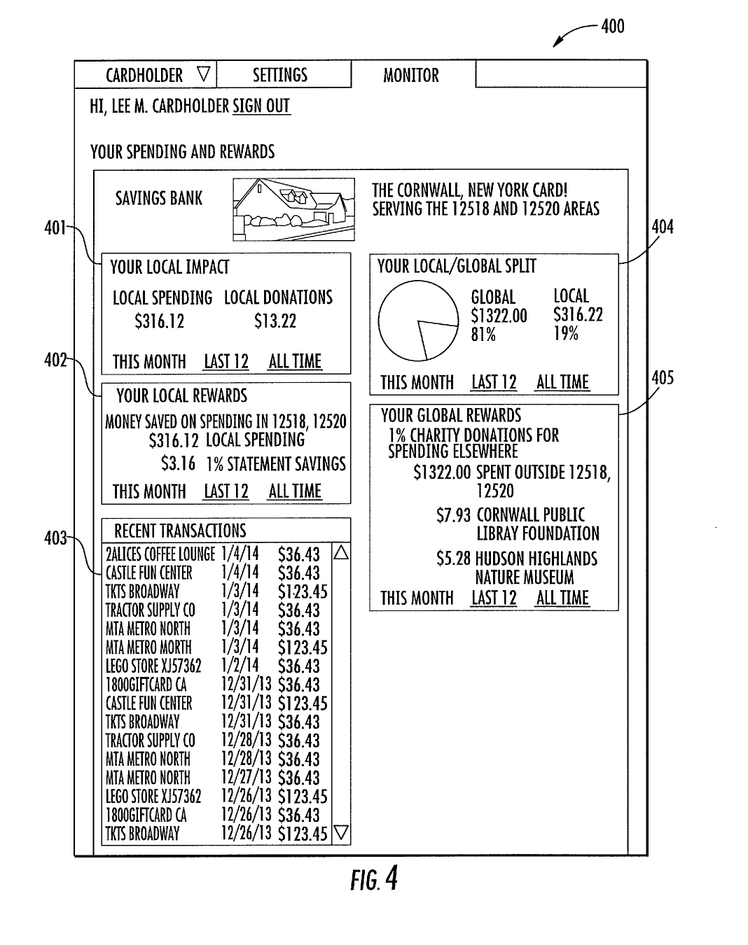

The website management platform may also be configured to enable a cardholder user to monitor and manage the community-based payment card account. For example, an associated web portal may enable a cardholder to perform such tasks as viewing the amount of spend conducted within the local area, viewing the amount of spend conducted outside of the local area, viewing the accumulated credits/refunds, viewing the accumulated charitable donations, viewing recent individual purchase transactions, and the like. For example, FIG. 4 illustrates an exemplary screen display of a web portal that may be utilized by a cardholder user to monitor and manage the community-based payment card reward program. For example, webpage 400 may include a first UI element 401 that is configured to display a financial summary of the user's participation in the community-based payment card reward program as it related to the designated local area (i.e., cardholder user's local impact). For example, UI element 401 may display the both the cardholder user's total amount of local spending and total amount of donations to local charitable entities. In addition, UI element 401 may provide the cardholder user the option to display these monetary amounts for any designated time period (e.g., current month, last 12 months, all-time, etc.).

In some embodiments, webpage 400 may similarly include a second UI element 402 that is configured to display the cardholder user's local rewards accumulated by making purchase transactions with merchant entities located in a local geographic area as designated by the community-based payment card reward program. For example, UI element 402 may be configured to display the total amount of local spending in the designated local areas (e.g., zip codes) and the total amount of statement savings (e.g., a credit or refund) earned by the cardholder user. In addition, UI element 402 may provide the cardholder user the option to display these monetary amounts for any designated time period (e.g., current month, last 12 months, all-time, etc.).

In some embodiments, webpage 400 may also include a third UI element 403 that lists the cardholder user's most recent purchase transactions. For each purchase transaction, UI element 403 may be configured to provide a merchant name and/or identifier, a purchase transaction date, and a purchase transaction amount. Although not shown in FIG. 4, in some embodiments, UI element 403 may also be configured to display a merchant location identifier (e.g., postal zip code) for each recent transaction listed. Webpage 400 may further include a fourth UI element 404 that displays the allocation of the cardholder user's local spending and non-local (i.e., global) spending. For example, UI element 404 may display such allocation in numerical terms, by relative percentages, and/or via an illustration, such a pie chart, bar graph, line graph, and the like. In addition, UI element 404 may provide the cardholder user the option to display the displayed monetary amounts and corresponding percentages for any designated time period (e.g., current month, last 12 months, all-time, etc.).

Webpage 400 may also include a fifth UI element 405 that displays the user's non-local (i.e., global) rewards accumulated from making purchases with non-local merchant entities (e.g., merchant entities located outside of the local area designated by the cardholder user's community-based payment card reward program). For example, UI element 405 may be configured to display the total amount of global spending in non-local areas (e.g., outside designated zip codes) and the total donation amounts for each respective designated charitable entity. In addition, UI element 405 may provide the cardholder user the option to display these monetary amounts for any designated time period (e.g., current month, last 12 months, all-time, etc.).

Returning to FIG. 1, after utilizing web portal access device 106 to enroll in the community-based payment card reward program, the cardholder user may utilize the community-based payment card to conduct purchase transactions and begin accumulating credit rewards and donation amounts. As used herein, a purchase transaction may include at least one of a credit card purchase transaction, a debit card purchase transaction, a prepaid card purchase transaction, or the like. In some embodiments, a cardholder user may initiate a purchase transaction for a merchandise product at reader device 116 and POS device 114 at a merchant site location, such as a brick and mortar merchant store. In some embodiments, POS device 114 may include any type of device or unit that is configured to facilitate a payment card transaction. Exemplary POS devices include self-service kiosks, self-checkout units, point of sale cashier terminals/registers, and the like. POS device 114 may also be configured to communicate with a nearby reader device, such as reader device 116. Exemplary reader devices may include a magnetic stripe reader, a wireless smartcard reader, a wireless device reader, and the like. For example, reader device 116 in FIG. 1 may include a magnetic stripe card reader that is configured to read a magnetic stripe card 122 (e.g., a plastic payment card) that is swiped by a cardholder user. In some embodiments, reader device 116 may also or alternatively comprise a wireless device reader that is configured to wirelessly communicate with a cardholder user's near field communications (NFC) enabled smartcard or mobile device 124 in order to wirelessly receive payment card information (e.g., credit card credentials) to initiate a purchase transaction at POS device 114 (e.g., wirelessly receiving credit card data associated with a payment card “softcard” application provisioned on the smart card or mobile device). For example, mobile device 124 may be configured to communicate payment card data with a wireless device reader 116 via near field communications (NFC) to initiate the purchase transaction.

Upon presenting and/or interfacing the community-based payment card (e.g., a magnetic strip card 122 or an electronic credit card provisioned on mobile device 124) with reader device 116, POS device 114 obtains credit card credentials and related data from the credit card and subsequently generates purchase transaction data. Exemplary purchase transaction data may include, but is not limited to, i) a cardholder account number (e.g., a primary account number or PAN), ii) a merchant identifier, iii) a merchant site identifier (e.g., a postal zip code of the merchant entity store location), and/or iv) a purchase transaction amount. The purchase transaction data may then be sent from POS device 114 to program management server 102 as a payment card authorization request message via transaction network gateway 112. Although not shown in FIG. 1, the payment card authorization request message may also traverse other network elements, such as an acquirer entity server or network routing server, prior to reaching the transaction network gateway 112 or program management server 102. In some embodiments, transaction network gateway 112 may include any gateway server, node, or unit that serves as an entry and exit point for communications (e.g., packet traffic) entering and leaving a payment transaction network and associated infrastructure (e.g., MasterCard network infrastructure or “MasterCard payment network”). Transaction network gateway 112 can be communicatively connected to program management server 102, which may also be located within the payment transaction network.

Upon receiving the payment card authorization request, transaction network gateway 112 may be configured to perform a plurality of functions. For example, transaction network gateway 112 may generate a copy of the payment card authorization request message containing the purchase transaction data prior to forwarding the original payment card authorization request message to issuer entity 104 for payment authorization and processing. Transaction network gateway 112 may then forward the copy of the payment card authorization request message containing the purchase transaction data to program management server 102. As an alternative to copying and forwarding the payment card authorization request message, transaction network gateway 112 may instead be configured to extract the purchase transaction data from the payment card authorization request message received from merchant entity 108 and subsequently generate a purchase indication message that includes the extracted purchase transaction data. Afterwards, transaction network gateway 112 may send purchase indication message containing the purchase transaction data to program management server 102. In some embodiments, each of the payment card authorization request message and the purchase indication message may comprise a web based message, such as an XML request message. However, each of the payment card authorization request message and the purchase indication message may be generated in any web based protocol, format, or specification in alternative embodiments without departing from the scope of the present subject matter.

Regardless of the manner in which the purchase transaction data is received (e.g., payment card authorization request message copy or purchase indication message), program management server 102 may be configured to utilize the purchase transaction data to determine if the purchase transaction was conducted in a local area as designated by established parameters (e.g., zip code(s) designating the local area) specified by the cardholder user's account. In some embodiments, program management server 102 utilizes the cardholder account information and merchant store location information (e.g., address and/or zip code data) contained in the received message to determine if the associated purchase transaction qualifies as a local or non-local purchase. For example, program management server 102 may conduct a comparison between the received zip code corresponding to the merchant site location and the zip code(s) previously designated by the issuer entity (e.g., see UI element 204 in FIG. 2) to be the local service area. If a match exists, then program management server 102 may designate the purchase transaction as a local purchase transaction. If a match does not exist, then program management server 102 may designate the purchase transaction as a non-local purchase transaction. In some embodiments, the zip codes identifying a local area for each community-based payment card reward program that is supported by program management server 102 are securely stored in data storage unit 126.

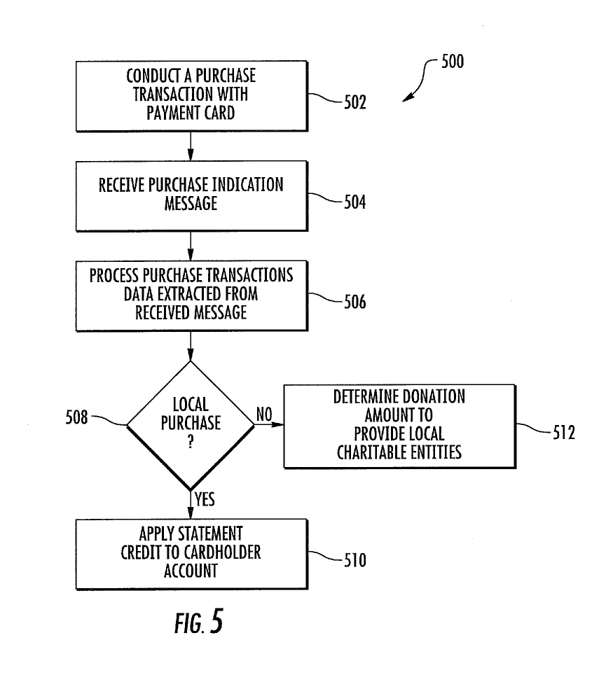

FIG. 5 depicts a flow chart illustrating an exemplary method 500 for providing benefits to local community entities via purchase card transactions according to an embodiment of the subject matter described herein. In step 502, a purchase transaction is conducted with a community reward payment card. In some embodiments, a consumer utilizes the community reward payment card to purchase a good or service at a merchant entity's store site (e.g., a brick and mortar merchant store). For example, the community reward payment card may be presented and utilized at a point of sale, either via the swiping of magnetic swipe card 116 at a magnetic card stripe reader connected to a point of sale device or via NFC conducted between a wireless device reader and an NFC enabled mobile device 124 (or smart card) to initiate the purchase transaction.

In step 504, a purchase indication message is received at a program management server. In some embodiments, purchase transaction data associated with the conducted purchase transaction in step 502 is sent from merchant entity 108 to issuer entity 104 via transaction network gateway 112. In some embodiments, merchant entity 108 may generate and send a payment card authorization request message that includes purchase transaction data that includes details corresponding to the purchase transaction conducted by the consumer user at the merchant store site. Upon receipt of the message, transaction network gateway 112 may forward a copy of the payment card authorization request message containing the purchase transaction data to program management server 102 (i.e., the original payment card authorization request message is forwarded to issuer entity 104 for payment authorization and processing). In some alternate embodiments, transaction network gateway 112 may be configured to i) extract purchase transaction data from the received payment card authorization request message, ii) generate a purchase indication message that includes the extracted purchase transaction data, and iii) send the generated purchase indication message to program management server 102. Exemplary purchase transaction data included in the payment card authorization request message and/or the purchase indication message includes, but is not limited to, i) a cardholder account number, ii) a merchant identifier, iii) a merchant site identifier (e.g., a zip code of the merchant entity store location), and/or iv) a purchase transaction amount.

At step 506, purchase transaction data is extracted and processed. In some embodiments, program management server 102 may be configured (e.g., via execution of website management module 120 by processor 118) to extract purchase transaction data from the received copy of the payment card authorization request message (or the purchase indication message). In some embodiments, program management server 102 may extract a cardholder account number, a merchant site identifier, and a purchase transaction amount. In some embodiments, program management server 102 may be configured to utilize the extracted cardholder account number to access a cardholder's payment card account, which specifies the account's local area designation.

In some embodiments, program management server 102 may subsequently compare the extracted merchant site identifier (e.g., merchant site zip code) with the local area designation to determine if the purchase transaction was conducted either in the consumer's designated local area or in a non-local area. For example, at step 508, a determination is made as to whether or not the purchase transaction conducted by the cardholder user qualified as a local purchase transaction. In some embodiments, program management server 102 may be configured to conduct such a determination by comparing a merchant site identifier zip code to a zip code corresponding to the local area designation indicated by the cardholder's account. If the purchase transaction qualifies as a local purchase transaction, then method 500 continues to step 510. If the purchase transaction is determined to be a non-local purchase transaction, then method 500 proceeds to step 512.

In step 510, a statement credit is applied to the cardholder account. In some embodiments, program management server 102 may be configured to process the extracted purchase transaction amount from the received purchase transaction data (e.g., obtained in steps 504-506) in response to determining that the purchase transaction qualified as a local purchase transaction. For example, program management server 102 may utilize both a predefined percentage value (e.g., 1%) established by the cardholder account and the purchase transaction amount to calculate a statement credit to be applied to the cardholder account. For example, if the local purchase transaction amount is equal to $200 and the predefined percentage value is equal to 1%, then program management server 102 applies a $2.00 statement credit (i.e., $200×1%=$2) to the cardholder account.

In step 512, a donation amount to be provided to at least one local charitable entity is determined. In some embodiments, program management server 102 may be configured to process the extracted purchase transaction amount from the received purchase transaction data (e.g., obtained in steps 504-506) in response to determining that the purchase transaction qualified as a local purchase transaction. For example, program management server 102 may utilize both a predefined percentage value (e.g., 1%) established by the cardholder account and the purchase transaction amount to calculate a donation amount to be awarded (e.g., immediately or at a later date) to the at least one charitable entity specified by the cardholder account. For example, if the non-local purchase transaction amount is equal to $300 and the predefined percentage value is equal to 1%, then program management server 102 designates a $3.00 donation amount (i.e., $300×1%=$3) to be awarded to the one or more charitable entities designated by the cardholder account.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for providing benefits to local community entities via purchase card transactions, the method comprising:
receiving, by a website management platform, a message indicating that a purchase transaction has been initiated with a purchase transaction card associated with a community-based payment card reward program managed via the website management platform;
using purchase transaction information contained in the message to determine if the purchase transaction was conducted in a local area specified by the community-based payment card reward program;
applying a credit to a cardholder account associated with the purchase transaction card based on a monetary amount of the purchase transaction in the event the purchase transaction is initiated at a merchant site located within the local area; and
determining, based on the monetary amount associated with the purchase transaction, a donation amount to be provided to at least one charitable entity located within the local area in the event the purchase transaction is initiated at a merchant site located outside of the local area.

2. The method of claim 1 wherein the local area is defined, via the website management platform, by an issuer entity responsible for issuing the purchase transaction card.

3. The method of claim 2 wherein the issuer entity utilizes the website management platform to define a percentage value correlated to each of the credit and the donation amount.

4. The method of claim 2 further comprising: receiving, via the website management platform, a designation of a customized image associated with the issuer entity to be displayed on a front face of the purchase transaction card.

5. The method of claim 2 wherein the credit and the donation amount is funded by the issuer entity.

6. The method of claim 2 wherein the issuer entity utilizes the website management platform to designate a plurality of qualified charitable entities that includes the at least one charitable entity.

7. The method of claim 6 further comprising: receiving, via the website management platform from a cardholder user associated with the cardholder account, designations of the at least one charitable entity from among a plurality the qualified charitable entities located within the local area.

8. The method of claim 1 wherein the message includes either a purchase indication message or a payment card authorization request message.

9. The method of claim 1 wherein the local area includes a geographical area defined by one or more zip codes.

10. A system for providing benefits to local community entities via purchase card transactions, the system comprising:
at least one processor;
memory; and
a website management module (WMM) utilizing the at least one processor and the memory, wherein the WMM is configured to:
receive, by a website management platform, a message indicating that a purchase transaction has been initiated with a purchase transaction card associated with a community-based payment card reward program managed via the website management platform;
use purchase transaction information contained in the message to determine if the purchase transaction was conducted in a local area specified by the community-based payment card reward program;
apply a credit to a cardholder account associated with the purchase transaction card based on a monetary amount of the purchase transaction in the event the purchase transaction is initiated at a merchant site located within the local area; and
determine, based on the monetary amount associated with the purchase transaction, a donation amount to be provided to at least one charitable entity located within the local area in the event the purchase transaction is initiated at a merchant site located outside of the local area.

11. The system of claim 10 wherein the local area is defined, via the website management platform, by an issuer entity responsible for issuing the purchase transaction card.

12. The system of claim 11 wherein the issuer entity utilizes the website management platform to define a percentage value correlated to each of the credit and the donation amount.

13. The system of claim 11 further comprising: receiving, via the website management platform, a designation of a customized image associated with the issuer entity to be displayed on a front face of the purchase transaction card.

14. The system of claim 11 wherein the credit and the donation amount is funded by the issuer entity.

15. The system of claim 11 wherein the issuer entity utilizes the website management platform to designate a plurality of qualified charitable entities that includes the at least one charitable entity.

16. The system of claim 15 further comprising: receiving, via the website management platform from a cardholder user associated with the cardholder account, designations of the at least one charitable entity from among a plurality the qualified charitable entities located within the local area.

17. The system of claim 10 wherein the message includes either a purchase indication message or a payment card authorization request message.

18. The system of claim 10 wherein the local area includes a geographical area defined by one or more zip codes.

19. A non-transitory computer readable medium having stored thereon executable instructions for controlling a computer to perform steps comprising:
receiving, by a website management platform, a message indicating that a purchase transaction has been initiated with a purchase transaction card associated with a community-based payment card reward program managed via the website management platform;
using purchase transaction information contained in the message to determine if the purchase transaction was conducted in a local area specified by the community-based payment card reward program;
applying a credit to a cardholder account associated with the purchase transaction card based on a monetary amount of the purchase transaction in the event the purchase transaction is initiated at a merchant site located within the local area; and
determining, based on the monetary amount associated with the purchase transaction, a donation amount to be provided to at least one charitable entity located within the local area in the event the purchase transaction is initiated at a merchant site located outside of the local area.
